(19) United States
(12) Patent Application Publication
(10) Pub. No.: US 2025/0229674 A1
(43) Pub. Date: Jul. 17, 2025

(54) OSCILLATING FRAMEWORK FOR A VEHICLE SEAT, IN PARTICULAR AN OSCILLATING SEAT AND/OR UTILITY VEHICLE SEAT, AND A VEHICLE SEAT OF THIS TYPE

(71) Applicant: Adient US LLC, Plymouth, MI (US)

(72) Inventors: Harald KLEIN, Matzenbach (DE); Jens SCHULZ, Schauren (DE)

(73) Assignee: Adient US LLC, Plymouth, MI (US)

(21) Appl. No.: 19/012,411

(22) Filed: Jan. 7, 2025

(30) Foreign Application Priority Data
Jan. 12, 2024 (DE) 10 2024 200 286.0

(51) Int. Cl. B60N 2/04

(52) U.S. Cl. CPC B60N 2/045

(57) ABSTRACT

An oscillating framework for a vehicle seat, such as an oscillating seat and/or a utility vehicle seat, may have at least one lower frame and a link which is capable of oscillating, may be movable relative to the lower frame and may be coupled at least at a lower link end via a transverse rod to the lower frame. At at least one position detection device for detecting an assumed relative position of the transverse rod may be arranged in the lower frame. The transverse rod may be conjointly movable about an axis of rotation during movement of the link.

### FIELD

The invention relates to an oscillating framework for a vehicle seat, in particular an oscillating seat and/or a utility vehicle seat, comprising at least one lower frame and a link which is movable relative to the lower frame and is coupled at least at a lower link end via a transverse rod to the frame, and to a vehicle seat.

### BACKGROUND

EP 2 321 149 B1 discloses a vehicle seat, in particular utility vehicle seat, having a scissors-type framework which is capable of oscillating in a main oscillating direction and has an upper frame, two first links and two second links which intersect in pairs at a scissor axis running in the transverse direction of the seat, wherein the two first links are connected to each other at one end by a transverse tube which runs in the transverse direction of the seat and is mounted rotatably on the upper frame using at least one bearing device, wherein horizontal oscillations of the upper frame in the longitudinal direction of the seat are not damped by at least one oscillating device in the event of small deflections and are damped by the bearing device in the event of large deflections.

### SUMMARY

The invention is based on the problem of improving an oscillating framework of the type mentioned at the beginning, in particular of permitting measurement of a height, in particular a seat height, in an oscillating seat in a simple manner, and of providing a corresponding vehicle seat.

This problem is solved according to the invention by an oscillating framework for a vehicle seat, in particular an oscillating seat and/or a utility vehicle seat, comprising at least one lower frame and a link which is in particular capable of oscillating, is movable relative to the lower frame and is coupled at least at a lower link end via a transverse rod to the frame, wherein at least one position detection device for detecting an assumed relative position of the transverse rod is arranged in the lower frame, wherein the transverse rod is conjointly movable about an axis of rotation during movement of the link.

Owing to the fact that at least one position detection device for detecting an assumed relative position of the transverse rod is arranged in the lower frame, wherein the transverse rod is conjointly movable about an axis of rotation during movement of the link, a current height, in particular seat height, of the vehicle seat, in particular an oscillating seat, can be monitored in a simple manner.

An oscillating seat or link which is capable of oscillating is understood as meaning a seat or a link that can be deflected, for example, due to road bumps. The oscillating seat or the link which is capable of oscillating can counteract, for example damp, unpleasant impacts on poor road surfaces. As a result, for example, seating comfort, for example during longer travel distances, can be increased.

The vehicle seat may be, for example, a suspension seat. The oscillating framework may be a suspension.

The arrangement of the position detection device within the lower frame permits both a preassemblable or preassembled and optionally testable assembly. In addition, this arrangement permits a space-saving use of an existing construction space.

Advantageous refinements which can be used individually or in combination with one another are the subject matter of the dependent claims.

For example, level control can be provided, wherein detection of the relative position of the transverse rod, resulting from a movement of the link, makes it possible to determine a deflection of the link or of the oscillating framework and/or a current height position of the vehicle seat. If, for example, an actual value of the height differs from a desired value, as a rule due to a deflection of the link or of the oscillating framework, the level control can be activated in order, for example, to counteract the deflection such that the actual value reaches the desired value again. The level control can comprise, for example, at least one control device and a controllable suspension device.

The position detection device can be designed to determine a deflection of the link and/or a height, in particular seat height, of the vehicle seat with reference to the detected relative position of the transverse rod.

Determining, for example monitoring, the current deflection and/or the current height position also makes it possible to improve a height setting of the vehicle seat. For the height setting, the desired value can be changed depending on a height to be newly set, and therefore the level control treats the current actual value as a deviation from the desired value and brings the oscillating framework to the desired new height.

The lower link end can be connected to the transverse rod for rotation therewith. As a result, the transverse rod follows the movement, for example the deflection, of the link.

In a development, the transverse rod can be activatable for moving the link. For different height positions of the vehicle seat, the transverse rod can be adjusted, for example, by an angular value. For example, in order to set a height position, the transverse rod can be rotated by 26° in each case.

The position detection device can be arranged in an articulation region of the transverse rod in and/or on the lower frame. In particular, the position detection device can be completely arranged in a cavity of the lower frame. In addition, no change to an already existing metal structure and to bearing structures of the lower frame or of an upper frame needs to be made.

At least one bearing element can be arranged in a cavity of the lower frame, wherein the bearing element can comprise a bearing receptacle in which the transverse rod can be held in a rotatably guided manner, wherein the position detection device can be arranged at a bearing end opposite the bearing receptacle.

The position detection device can comprise at least one angle sensor which can be designed to detect an angular position of the transverse rod as a relative position, wherein a permanent magnet interacting with the angle sensor can be arranged on and/or in the transverse rod. The position detection device can comprise, for example, a magnetic angle sensor. The permanent magnet can be fastened in a centered manner in the transverse rod.

The angle sensor can be arranged on a rear side or front side of the bearing element and can comprise at least one printed circuit board and a sensor element arranged thereon for measuring a rotation of the permanent magnet.

A sensor signal can be detected non-linearly to the height of the oscillating framework. The sensor signal can be detected as an absolute signal. The detection or measurement of the rotation, in particular the angular position, of the transverse rod can be undertaken in particular contactlessly. Wear can thereby be reduced.

In a development, the position detection device can optionally be arranged in an upper frame of the oscillating framework. In a development, the angle sensor can be arranged in and/or on the transverse rod and the permanent magnet in and/or on the lower frame.

A measurement of the seat height in an oscillating seat can be undertaken by determining an adjustment angle. By determining the angle of the transverse rod and thus of the link, the current seat height of the seat can be determined.

The transverse rod can comprise a cavity in which a magnet carrier can be fastened. The magnet carrier can be fastened, for example, in the cavity at least in a form-fitting, force-fitting and/or integrally bonded manner. The magnet carrier can have a magnet receptacle for receiving the permanent magnet.

The link can be capable of oscillating, wherein an upper link end of the link can be held in a manner guided movably in the seat longitudinal direction on an upper frame via a sliding element, wherein a height of the upper frame with respect to the lower frame can be changeable by a movement of the link.

At least one oscillatable pair of links can be provided, wherein the links can intersect at a scissor axis and can be pivotable relative to each other about the scissor axis. The pair of links can be designed as adjustment scissors, for example height adjustment scissors.

The oscillating framework can be designed as a scissors-type framework. The oscillating framework can have, for example, two pairs of links arranged spaced apart from each other in the transverse direction. Two opposite links of the pairs can be connected to each other via the transverse rod. Determining the angle of the scissors-type framework, in particular of the height adjustment scissors, makes it possible to determine the current height of the seat. Detecting the deflection, which can be detected by the position detection device, during the oscillation of the scissors-type framework makes it possible to ascertain the current height position, for example an actual value of the height, with very substantial measurement accuracy, as a result of which ultimately both level control and a height setting can be improved.

The invention furthermore relates to a vehicle seat, in particular oscillating seat and/or utility vehicle seat, having at least one seat part and an oscillating framework, which is connected to the seat part, according to the previous description, wherein the oscillating framework comprises at least one lower frame and a link which is in particular capable of oscillating, is movable relative to the lower frame and is coupled at least at a lower link end via a transverse rod to the frame. At least one position detection device for detecting an assumed relative position of the transverse rod is arranged in the lower frame of the oscillating framework, wherein the transverse rod is conjointly movable about an axis of rotation during movement of the link. A current height of the oscillating framework, in particular a seat height of the vehicle seat, in particular of an oscillating seat, can be determined by the position detection device by measuring the angle in the oscillating kinematics. The vehicle seat can be a utility vehicle seat, for example what is referred to as a commercial vehicle seat.

The oscillating framework can be a scissors-type framework which is capable of oscillating and is optionally additionally height-adjustable. Measuring the angle of the scissors kinematics makes it possible to determine the seat height of the seat. The oscillating framework, in particular scissors-type framework, can comprise a lower frame, an upper frame arranged above the latter and a respective pair of intersecting links on both sides. A scissor axis can connect the two intersecting points of the links and at the same time define the axis about which the links can pivot relative to each other. The links can each be coupled at their rear end to the lower frame or to the upper frame and at their front end can each have sliding elements, for example rotatable rollers, by which the links can be guided movably in the seat longitudinal direction in or on the upper frame or lower frame. This movement of the links makes it possible to change the height of the upper frame over the lower frame, also referred to as height of the scissors-type framework.

### DESCRIPTION OF THE FIGURES

The invention is explained in more detail below with reference to advantageous exemplary embodiments which are illustrated in the figures. However, the invention is not limited to these exemplary embodiments. In the figures:

FIG. 1: shows a schematic illustration of a vehicle seat with a longitudinal adjustment device according to the prior art,

FIG. 2: schematically shows a perspective front view of an oscillating framework according to the invention, in particular a scissors-type framework which is capable of oscillating, according to a first exemplary embodiment,

FIG. 3: schematically shows a perspective rear view of the oscillating framework according to the invention,

FIG. 4: schematically shows an enlarged detail in the region of a lower frame of the oscillating framework according to the invention,

FIG. 5: schematically shows a further enlarged detail in the region of the lower frame of the oscillating framework according to the invention,

FIG. 6: schematically shows a perspective view of a covering element for covering a position detection device of the oscillating framework according to the invention,

FIG. 7: schematically shows a perspective view of a rod end of a transverse rod according to a first exemplary embodiment,

FIG. 8: schematically shows a perspective view of a magnet carrier, which can be arranged or is arranged in a transverse rod, according to a first exemplary embodiment, and

FIG. 9: schematically shows a perspective view of an angle sensor of the position detection device according to a first exemplary embodiment.

### DETAILED DESCRIPTION

Mutually corresponding parts are provided with the same reference signs throughout the figures.

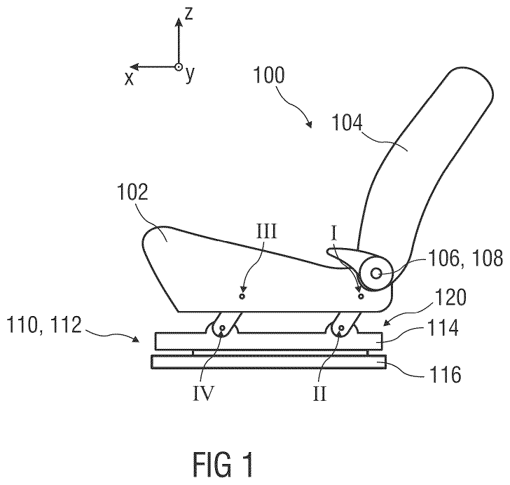

A vehicle seat 100 schematically illustrated in FIG. 1 of the prior art will be described below using three mutually perpendicular spatial directions. In the case of a vehicle seat 100 installed in the vehicle, a longitudinal direction x runs substantially horizontally and preferably parallel to a vehicle longitudinal direction, which corresponds to the normal direction of travel of the vehicle. A transverse direction y, which runs perpendicular to the longitudinal direction x, is likewise oriented horizontally in the vehicle and runs parallel to a vehicle transverse direction. A vertical direction z runs perpendicular to the longitudinal direction x and perpendicular to the transverse direction y. In the case of a vehicle seat 100 installed in the vehicle, the vertical direction z preferably runs parallel to a vehicle vertical axis.

The position and directional statements used, such as front, rear, top and bottom, relate to a viewing direction of an occupant seated in the vehicle seat 100 in a normal seating position, wherein the vehicle seat 100 is installed in the vehicle in a usage position suitable for conveying passengers, with an upright backrest 104, and is oriented in the conventional manner in the direction of travel. The vehicle seat 100 may however also be installed or moved in a different orientation, for example transversely with respect to the direction of travel. Unless described differently, the vehicle seat 100 is constructed mirror-symmetrically to a plane running perpendicularly to the transverse direction y.

The backrest 104 can be arranged pivotably on a seat part 102 of the vehicle seat 100. For this purpose, the vehicle seat 100 can optionally comprise a fitting 106, in particular an adjustment fitting, rotary fitting, latching fitting or tumble fitting.

The position and directional statements used, such as radially, axially and in the circumferential direction, relate to an axis of rotation 108 of the fitting 106.

Radially means perpendicular to the axis of rotation 108. Axially means in the direction of or parallel to the axis of rotation 108.

The vehicle seat 100 can optionally comprise a longitudinal adjustment device 110. The longitudinal adjustment device 110 comprises, for example, a rail arrangement 112 with a first rail element 114 and a second rail element 116. The first rail element 114 is adjustable relative to the second rail element 116 in the longitudinal direction x. The first rail element 114 is fastened to the seat part 102. The second rail element 116 is fastened to a structural element of a vehicle, for example to a vehicle floor.

For better clarity, the first rail element 114 is referred to in the description below as upper rail 114. Said upper rail 114 (also called running rail or slide) is assigned to the vehicle seat 100 and designed to support said vehicle seat 100. The second rail element 116 is referred to below as lower rail 116. The lower rail 116 is connected fixedly and, for example, to the floor of a vehicle.

Furthermore, an oscillating framework 120, for example oscillating kinematics and/or height adjustment kinematics, can be arranged between the vehicle seat 100, in particular between the seat part 102 and the longitudinal adjustment device 110 and/or a vehicle floor.

The oscillating framework 120 can have a respective joint arrangement (I, II, III, IV), for example a four-joint arrangement, on both sides of the seat part 102. The joint arrangements (I, II, III, IV) can be constructed substantially identically.

The seat part 102 can be displaceable together with the oscillating framework 120 using two pairs of rails with which the vehicle seat 100 can be adjustable translationally in the longitudinal direction x. The two pairs of rails are arranged offset with respect to each other in the transverse direction y and parallel to each other.

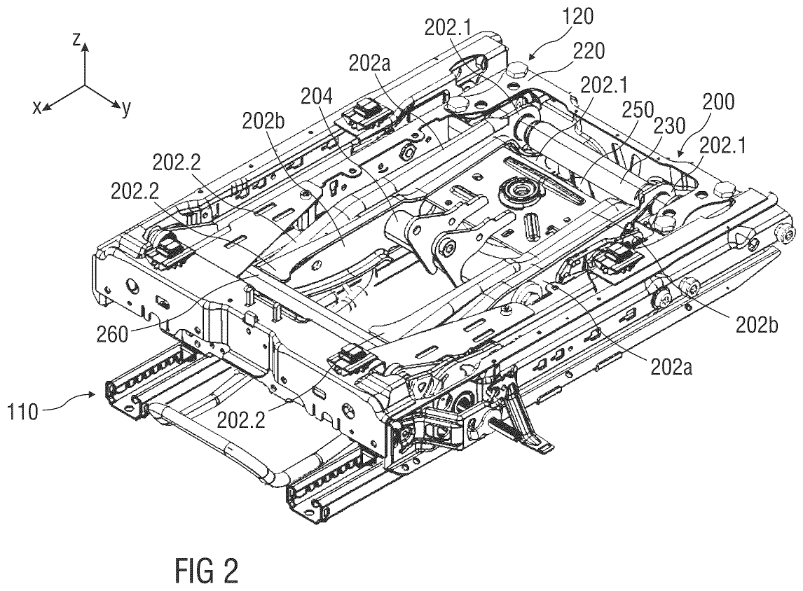

FIG. 2 schematically shows a perspective view of an oscillating framework 120 according to the invention, in particular an oscillating framework 120 which is capable of oscillating and is optionally height-adjustable.

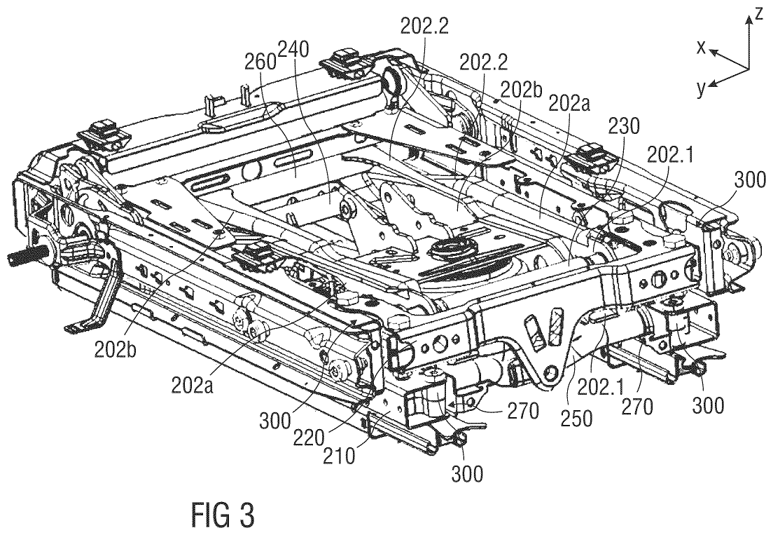

The oscillating framework 120 is in particular a scissors-type framework 200. The oscillating framework 120, in particular the scissors-type framework 200, comprises at least one lower frame 210, which is visible in more detail in FIG. 3, and an upper frame 220. The lower frame 210 and the upper frame 220 are arranged spaced apart from each other in the vertical direction z. The oscillating framework 120 comprises a respective pair of intersecting links 202a, 202b on both sides. The pairs of links 202a, 202b connect the two frames movably to each other. The pairs support the upper frame 220 movably on the lower frame 210.

A scissor axis 204 connects the two intersecting points and at the same time defines the axis about which the links 202a, 202b can pivot relative to each other. The links 202a, 202b are each coupled at their rear link end 202.1 to the lower frame 210 or to the upper frame 220 and at their front link end 202.2 each have sliding elements (not illustrated specifically), for example rotatable rollers, by which said links are guided movably in the longitudinal direction x in or on the upper frame 220 or lower frame 210. This movement of the links 202a, 202b changes the height of the upper frame 220 above the lower frame 210, also referred to below as height of the scissors-type framework 200 for short.

For example, a level control device (not illustrated specifically), for example at least comprising a gas-filled spring and a damper, makes it possible for the scissors-type framework 200 to be a system which is capable of oscillating and which increases the seating comfort.

FIG. 3 schematically shows a perspective rear view of the oscillating framework 120 according to the invention, in particular the scissors-type framework 200.

The two pairs of intersecting links 202a, 202b each comprise a first link 202a and a second link 202b, wherein the inside of the first link 202a and the outside of the second link 202b face each other.

The two first links 202a are fixedly connected to each other at their upper, here rear link end 202.1 by a transverse rod 230 and are coupled movably, in particular rotatably, to the upper frame 220. The first links 202a are connected to each other at their lower, here front link ends 202.2 by a further transverse rod 240. The transverse rod 240 can be guided movably in the longitudinal direction x on the lower frame 210 on both sides by a respective bearing device (not illustrated specifically).

The second links 202b are connected to each other at their lower, here rear link ends 202.1 by a transverse rod 250 and are coupled movably, in particular rotatably, to the lower frame 210. The transverse rod 250 can be mounted on the lower frame 210 directly and/or via a bearing element 300. At their upper, here front link ends 202.2, the second links 202b are likewise connected by a transverse rod 260 and are guided movably in the longitudinal direction x in the upper frame 220 on both sides, for example, by a respective bearing device (not illustrated specifically).

The transverse rods 230 to 260 each run in the transverse direction y parallel to the scissor axis 204. A movement, in particular pivoting movement, of the first links 202a relative to the second links 202b about the scissor axis 204 changes the height of the upper frame 220 above the lower frame 210.

A control device (not illustrated specifically) can be provided and can be used both for level control, i.e. retaining a set height of the scissors-type framework 200 during driving, and also optionally for setting the height of the scissors-type framework 200.

At least one position detection device 400 is provided for ascertaining a current height position of the oscillating framework 120, in particular the scissors-type framework 200. The at least one position detection device 400 can be arranged in particular in one of the articulation regions 270 between one of the transverse rods 230 to 260 and the lower frame 210 or the upper frame 220. As a result, the position detection device 400 can be arranged in a space-saving manner in the lower frame 210 and/or in the upper frame 220.

The fact that it is possible to ascertain the current height position of the scissors-type framework 200 means that it is possible to derive a current height position of the vehicle seat 100. This permits an improvement in the level control and/or the height adjustment if the scissors-type framework 200 undergoes deflections, for example due to road bumps. Accordingly, the deflection can be monitored by the position detection device 400.

The scissors-type framework 200 can be displaceable in the longitudinal direction x using the longitudinal adjustment device 110. The vehicle seat 100 can furthermore have a seat frame (not illustrated specifically) which can be fastened to the upper frame 220. In a development, the seat frame, for example a seat surface, can be formed integrally with the upper frame 220. The scissors-type framework 200 can be coupled directly to the seat frame of the vehicle seat 100 and can connect it to the lower frame 210.

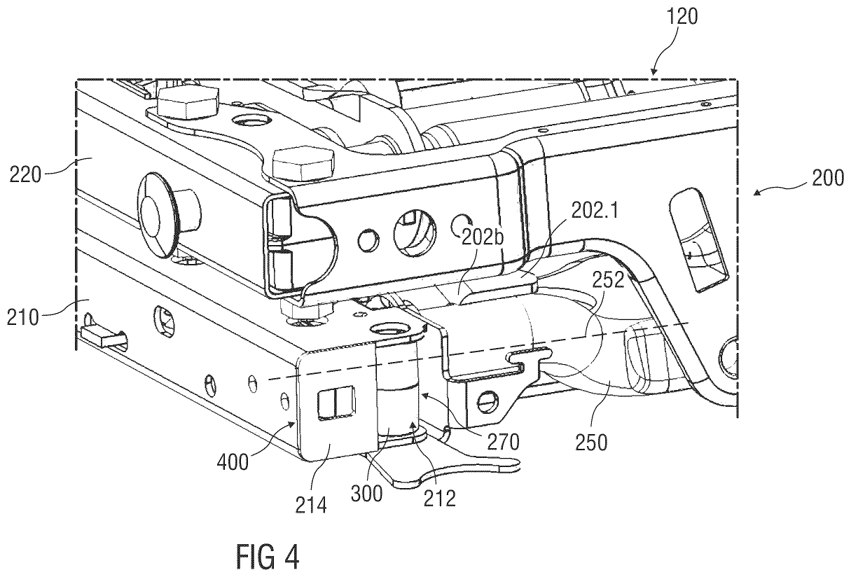

FIG. 4 schematically shows an enlarged detail in the region of a lower frame 210 of the oscillating framework 120 according to the invention, in particular the scissors-type framework 200.

The lower frame 210, and optionally also the upper frame 220, can have a substantially U-shaped or C-shaped profile. The lower frame 210 can have a profile, for example in the form of a rail profile, which is open at least in sections in the transverse direction y to the transverse rod 250 and receives the assigned bearing element 300 for the rotatable mounting of the transverse rod 250. The lower frame 210 can also have a closed profile with at least one passage opening through which the transverse rod 250 is guided. The bearing element 300 can be arranged, for example, in the cavity 212 of the lower frame 210. The cavity 212, in particular a profile opening, can be covered at the profile end of the lower frame 210 by a covering element 214.

For example, the position detection device 400 can be arranged at the profile end of the lower frame 210 and in the articulation region 270 of the transverse rod 250 and/or in the region of the bearing element 300.

The position detection device 400 which is arranged in the lower frame 210, or optionally in the upper frame 220, is provided for detecting an assumed relative position of the transverse rod 250, wherein the transverse rod 250 is conjointly movable about an axis of rotation 252 during movement of the assigned links 202b, for example a pivoting movement due to a deflection or height adjustment. The lower or rear link ends 202.1 of the links 202b are connected to the transverse rod 250 for rotation therewith. The transverse rod 250 can be conjointly moved, in particular conjointly pivoted or rotated, during a deflection and also during a height adjustment of the scissors-type framework 200. The respective rear link end 202.1 can be connected to the transverse rod 250 at least in an integrally bonded, form-fitting and/or force-fitting manner.

The axis of rotation 252 runs parallel to the scissor axis 204 and to the transverse direction y.

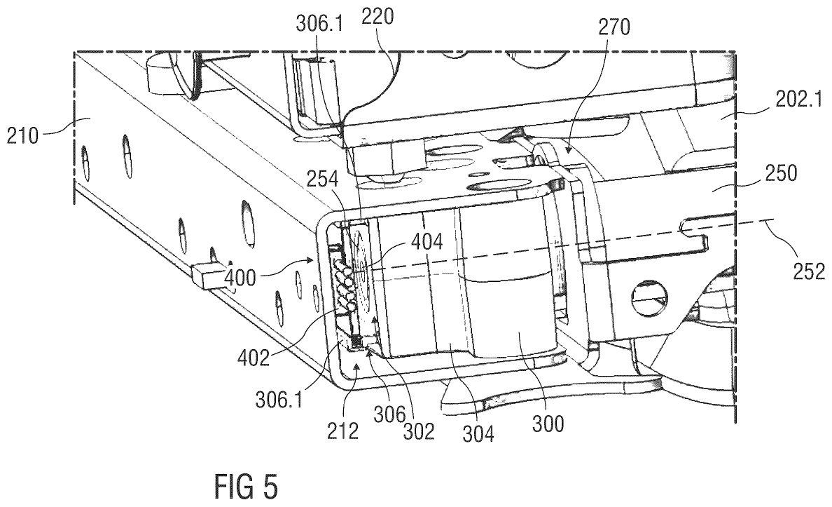

FIG. 5 schematically shows a further enlarged detail in the region of the lower frame 210 of the oscillating framework 120 according to the invention, in particular of the scissors-type framework 200. The covering element 214 has been omitted for the purpose of clarity in the illustrated exemplary embodiment.

The bearing element 300 is arranged in a cavity 212 of the lower frame 210. The bearing element 300 comprises a bearing receptacle 302, for example a bearing receptacle 302 which is continuous in the transverse direction y. The transverse rod 250 is held in a manner guided rotatably in the bearing receptacle 302. The position detection device 400 is arranged at an end opposite the bearing element 300 in the cavity 212 of the lower frame 210. The bearing element 300 can form a flush covering of an open profile side of a U-shaped or C-shaped lower frame profile. The bearing element 300 can have a bearing housing 304. A first side of the bearing element 300, for example a first housing side of the bearing housing 304, can cover the open profile side of the lower frame profile. A second side of the bearing element 300 opposite the first side, in particular a second housing side of the bearing housing 304, can have a holder 306. The holder 306 can have at least two opposite holding elements 306.1. The holding elements 306.1 can be designed as holding arms. The holding elements 306.1 can form a holding rail.

The position detection device 400 comprises at least one angle sensor 402 which is designed to detect an angular position of the transverse rod 250 as a relative position. The position detection device 400 comprises at least one permanent magnet 404 which interacts with the angle sensor 402. The angle sensor 402 can determine an angular position of the transverse rod 250 on the basis of detecting a magnetic field.

The angle sensor 402 can be fastened in the holder 306 of the bearing element 300. For example, the angle sensor 402 can be fixed, for example clamped or latched, between two holding elements 306.1 of the holder 306.

Alternatively, the angle sensor 402 can be fastened to an inner surface of the lower frame 210.

The permanent magnet 404 can be arranged in and/or at a rod end 254 of the transverse rod 250. In particular, the permanent magnet 404 can be arranged in and/or at a rod end 254 facing the angle sensor 402. The permanent magnet 404 can be fastened in and/or at the rod end 254 for rotation therewith.

Upon rotation of the transverse rod 250 about its axis of rotation 252, the permanent magnet 404 moves therewith, as a result of which there is a change in a magnetic field alignment, which is detectable by the angle sensor 402. The angular position of the transverse rod 250 can thereby be determined.

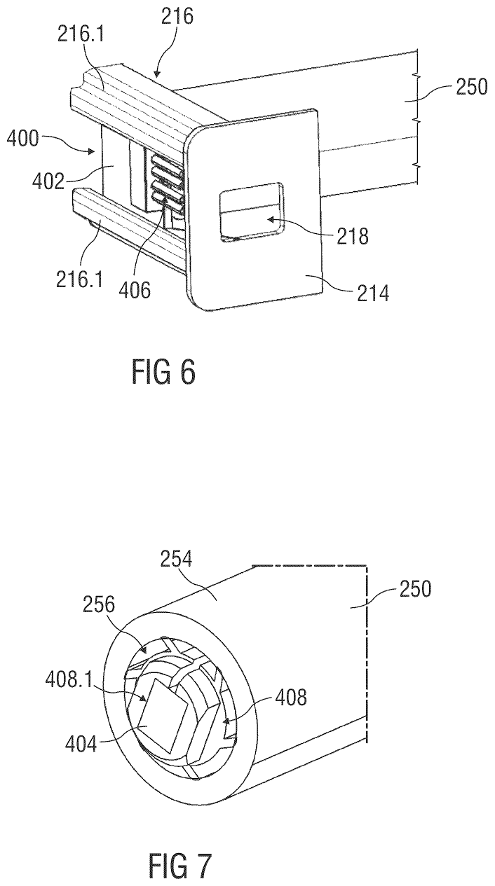

FIG. 6 schematically shows a perspective view of a covering element 214 for covering a position detection device 400 of the oscillating framework 120 according to the invention, in particular the scissors-type framework 200.

In this exemplary embodiment, the covering element 214 is provided with a holder 216 for receiving the angle sensor 402.

The covering element 214 can have holding elements 216.1 extending in the longitudinal direction x. The holder 216 can have at least two opposite holding elements 216.1. The holding elements 216.1 can be designed as holding arms. The holding elements 216.1 can form a holding rail. The angle sensor 402 can be fastened in the holder 216 of the covering element 214. For example, the angle sensor 402 can be fixed, for example clamped or latched, between two holding elements 216.1 of the holder 216. Alternatively, the angle sensor 402 can be fastened to an inner surface of the lower frame 210.

The covering element 214 can comprise a leadthrough 218, for example an opening, for the passage of a connecting cable 406 of the position detection device 400, in particular the angle sensor 402. The connecting cable 406 can be an integrated cable and/or a cable bundle.

FIG. 7 schematically shows a perspective view of a rod end 254 of a transverse rod 250 according to a first exemplary embodiment.

The transverse rod 250 can be designed as a tube. The transverse rod 250 can comprise a cavity 256 or at least one end-side cutout. The permanent magnet 404 can be fastened non-rotatably in the cavity 256. For this purpose, for example, a magnet carrier 408 can be provided. The magnet carrier 408 can be formed from plastic, for example polyamide (PA). The magnet carrier 408 can be fastened non-rotatably in the cavity 256 of the transverse rod 250.

The magnet carrier 408 can have at least one magnet receptacle 408.1 in which the permanent magnet 404 can be arrangeable or arranged.

The permanent magnet 404 can be formed, for example, from a conventionally suitable magnetic material, for example ferrite.

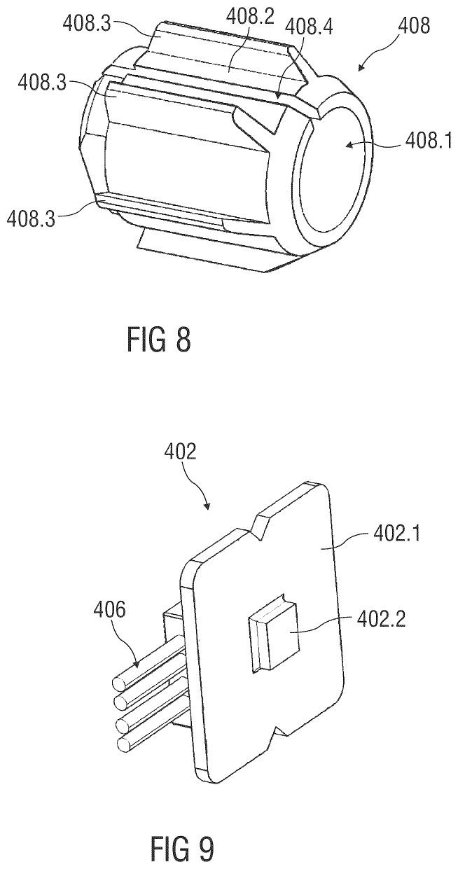

FIG. 8 schematically shows a perspective view of a magnet carrier 408 which can be arranged or is arranged in a transverse rod 250, according to a first exemplary embodiment.

The magnet carrier 408 can be a hollow-cylindrical sleeve. The magnet carrier 408 can comprise a basic body 408.2, for example a sleeve body. The magnet receptacle 408.1 can be, for example, a cavity extending through the basic body 408.2. The magnet carrier 408 can have a number of protruding, in particular radially protruding, fastening elements 408.3 on an outer circumference. The fastening elements 408.3 can be, for example, latching arms, latching lugs or latching hooks. The magnet carrier 408 can be arranged at least in a form-fitting manner in the cavity 256 of the transverse rod 250 via the fastening elements 408.3. The fastening elements 408.3 can be arranged at an angle to the outer circumference of the magnet carrier 408. As a result, bracing, in particular clamping, of the magnet carrier 408 in the cavity 256 can be simplified. The magnet carrier 408, in particular the basic body 408.2, can have a groove 408.4 indicating a pole direction of the permanent magnet 404. Correct alignment of the permanent magnet 404 during the installation can thereby be simplified.

FIG. 9 schematically shows a perspective view of an angle sensor 402 of the position detection device 400 according to an exemplary embodiment.

The angle sensor 402 can comprise a printed circuit board 402.1, for example a circuit board, and/or a suitable carrier, wherein the printed circuit board 402.1 and/or the carrier can be provided with at least one sensor element 402.2 for detecting a change in a pole alignment of the permanent magnet 404 relative to the angle sensor 402, and with a connecting cable 406. The angle sensor 402 can in particular be space-saving and compact and installed or integrated in a simple manner in a frame part of the lower frame 210 or of the upper frame 220.

### LIST OF REFERENCE SIGNS

100 vehicle seat
102 seat part
104 backrest
106 fitting
108 axis of rotation
110 longitudinal adjustment device
112 rail arrangement
114 first rail element (upper rail)
116 second rail element (lower rail)
120 oscillating framework
200 scissors-type framework
202a, 202b link
202.1 link end, in particular rear link end
202.2 link end, in particular front link end
204 scissor axis
210 lower frame
212 cavity
214 covering element
216 holder
216.1 holding element
220 upper frame
230 transverse rod
240 transverse rod
250 transverse rod
252 axis of rotation
254 rod end
256 cavity
260 transverse rod
270 articulation region
300 bearing element
302 bearing receptacle
304 bearing housing
306 holder
306.1 holding element
400 position detection device
402 angle sensor
402.1 printed circuit board
402.2 sensor element
404 permanent magnet
406 connecting cable
408 magnet carrier
408.1 magnet receptacle
408.2 basic body
408.3 fastening element
408.4 groove
X longitudinal direction
y transverse direction
Z vertical direction

1. An oscillating framework for a vehicle seat, comprising an oscillating seat and/or a utility vehicle seat, comprising at least one lower frame and a link which is capable of oscillating, is movable relative to the lower frame and is coupled at least at a lower link end via a transverse rod to the lower frame, wherein at least one position detection device for detecting an assumed relative position of the transverse rod is arranged in the lower frame, and wherein the transverse rod is conjointly movable about an axis of rotation during movement of the link.

2. The oscillating framework as claimed in claim 1, wherein the position detection device is designed to determine a deflection of the link and/or a seat height of the vehicle seat with reference to the detected relative position of the transverse rod.

3. The oscillating framework as claimed in claim 1, wherein the lower link end is connected to the transverse rod for rotation therewith.

4. The oscillating framework as claimed in claim 1, wherein the position detection device is arranged in an articulation region of the transverse rod in and/or on the lower frame.

5. The oscillating framework as claimed in claim 1, wherein at least one bearing element is arranged in a cavity of the lower frame, the bearing element comprising at least one bearing receptacle in which the transverse rod is held in a rotatably guided manner, wherein the position detection device is arranged at an end opposite the bearing element in the cavity of the lower frame.

6. The oscillating framework as claimed in claim 1, wherein the position detection device comprises at least one angle sensor which is designed to detect an angular position of the transverse rod as a relative position, wherein a permanent magnet interacting with the angle sensor is arranged on and/or in the transverse rod.

7. The oscillating framework as claimed in claim 1, wherein the transverse rod comprises a cavity in which a magnet carrier is fastened.

8. The oscillating framework as claimed in claim 1, wherein the link is capable of oscillating, wherein an upper link end of the link is held in a manner guided movably in the longitudinal direction on an upper frame via a sliding element, and wherein a height of the upper frame with respect to the lower frame is changeable by a movement of the link.

9. The oscillating framework as claimed in claim 1, which comprises at least one oscillatable pair of links which intersect at a scissor axis, wherein the links are pivotable relative to each other about the scissor axis.

10. A vehicle seat, comprising an oscillating seat and/or a utility vehicle seat, having at least one seat part and an oscillating framework, which is connected to the seat part, as claimed in claim 1.

11. The vehicle seat as claimed in claim 10, wherein the oscillating framework is a scissors-type framework which is capable of oscillating.
